(19) United States
(12) Patent Application Publication
(10) Pub. No.: US 2014/0188742 A1
(43) Pub. Date: Jul. 3, 2014

(54) SYSTEM TO INTEGRATE REAL-WORLD OBJECTS INTO SOCIAL NETWORKS

(71) Applicant: Google Inc., Mountain View, CA (US)

(72) Inventors: Thomas Deselaers, Zurich (CH); Damon Kohler, Munich (DE); Daniel Martin Keysers, Zurich (CH); Matthew Sharifi, Zurich (CH); Richard Zarek Cohen, London (GB); Benoit Boissinot, Zurich (CH); Stephan Robert Gammeter, Zurich (CH)

(21) Appl. No.: 13/843,144

(22) Filed: Mar. 15, 2013

Related U.S. Application Data
(60) Provisional application No. 61/747,883, filed on Dec. 31, 2012.

(51) Int. Cl. G06Q 30/02; G06Q 50/00

(52) U.S. Cl. CPC G06Q 30/0282; G06Q 50/01
USPC 705/319

(57) ABSTRACT

A method for displaying an aggregate count of endorsements is provided, including the following method operations: processing a request for an online resource from a mobile device, the online resource being associated with an object, the online resource including an endorsement mechanism; sending the online resource to the mobile device; processing an input from a user triggering the endorsement mechanism, to define an endorsement of the object by the user; updating an aggregate count of endorsements of the object to include the endorsement of the object by the user; sending the updated aggregate count of endorsements to the social display device for display on the social display device.

### CLAIM OF PRIORITY

This application claims priority to U.S. Provisional Application No. 61/747,883, filed Dec. 31, 2012, entitled “SYSTEM TO INTEGRATE REAL-WORLD OBJECTS IN SOCIAL NETWORKS,” the disclosure of which is incorporated by reference in its entirety for all purposes.

### BACKGROUND

The present disclosure relates to methods, systems, and computer programs for integrating real-world objects into social networks and having users engage with them.

In recent years, social networks have gained in popularity amongst internet users. Social networks enable users to hold representative accounts, and designate connections to other account holders, which may include friends or family members on the same social network. These connections determine a user's social graph, which defines the user and the others with whom the user is connected on the social network. Users can conduct a variety of activities based on their social graph, including sharing information and media with others, receiving updates from others, commenting on posted information, playing games, chatting, endorsing electronic information items such as websites or others' posts, etc.

The presence of social networks is becoming increasingly ubiquitous across the Internet. For example, it is possible for users to endorse something on a social network, such as a movie on the Internet, a page that the user has visited, or an article that the user has read. However, to date social networks have not been effectively integrated with the physical world. It is not yet easily possible to endorse physical objects when, for example, the objects and places do not have a representation on the Internet, when the user wishes to endorse an object or location the corresponding web address is not easily found. If a user sought to endorse something that he just bought or ate or saw, the user would have to find a corresponding webpage (or profile page on a social network) to be able to interact with it and indicate an interaction in the physical world on the social network.

### SUMMARY

Embodiments of the present disclosure provide methods, systems, and computer programs for integrating real-world objects into social networks and facilitating user engagement with them. It should be appreciated that the present disclosure can be implemented in numerous ways, e.g., a process, an apparatus, a system, a device or a method on a computer readable medium. Several embodiments of the present disclosure are described below.

In one embodiment, a method for displaying an aggregate count of endorsements is provided, including the following method operations: processing a request for an online resource from a mobile device, the online resource being associated with an object, the online resource including an endorsement mechanism; sending the online resource to the mobile device; processing an input from a user triggering the endorsement mechanism, to define an endorsement of the object by the user; updating an aggregate count of endorsements of the object to include the endorsement of the object by the user; sending the updated aggregate count of endorsements to the social display device for display on the social display device.

In one embodiment, the request for the online resource is defined from a tag on the social display device read by the mobile device to obtain a reference to the online resource.

In one embodiment, the reference is defined by a URL.

In one embodiment, the tag is defined by one or more of a barcode, an NFC tag, or a QR code.

In one embodiment, the online resource defines a social network page associated with the object.

In one embodiment, the online resource is defined by a website of an entity associated with the object.

In one embodiment, the entity is one or more of a retailer, a manufacturer, a restaurant, a business, a museum, or a library.

In one embodiment, processing the input from the user includes publishing the endorsement of the object by the user to one or more users in a social graph associated with the user.

In one embodiment, the endorsement of the object by the user is defined for a social network.

In one embodiment, processing the input includes retrieving and sending to the mobile device one or more of the following based on the endorsement of the object by the user: a recommendation, a coupon, a discount code, an invite, an offer.

In another embodiment, a method for displaying an aggregate count of endorsements is provided, including the following method operations: reading a tag on a social display device to obtain a reference to an online resource; retrieving the online resource, the online resource being associated with an object, the online resource including an endorsement mechanism; processing an input from a user triggering the endorsement mechanism; sending a request to a server to increase an aggregate count of endorsements of the object and propagate the aggregate count for display on the social display device.

In one embodiment, the tag is defined by one or more of a barcode, an NFC tag, or a QR code.

In one embodiment, the reference is defined by a URL.

In one embodiment, the online resource defines a social network page associated with the object.

In one embodiment, the online resource is defined by a website of an entity associated with the object.

In one embodiment, the entity is one or more of a retailer, a manufacturer, a restaurant, a business, a museum, or a library.

In one embodiment, the endorsement of the object by the user is shared to one or more users in a social graph associated with the user.

In one embodiment, the endorsement of the object by the user is defined for a social network.

In one embodiment, the method further includes: receiving one or more of the following based on the endorsement of the object by the user: a recommendation, a coupon, a discount code, an invite, an offer.

In another embodiment, a social display device for displaying an aggregate count of endorsements is provided, including the following: a readable tag encoding a reference to an online resource, the online resource being associated with an object, the online resource including an endorsement mechanism associated with the object, wherein triggering the endorsement mechanism defines an endorsement of the object by a user and updates an aggregate count of endorsements of the object to include the endorsement of the object by the user; a display configured to display the aggregate count.

Other aspects will become apparent from the following detailed description, taken in conjunction with the accompanying drawings.

### BRIEF DESCRIPTION OF THE DRAWINGS

The disclosure may best be understood by reference to the following description taken in conjunction with the accompanying drawings.

FIG. 1 illustrates an example architecture of a system for implementing embodiments of the disclosure, in accordance with embodiments of the present disclosure.

FIG. 2 illustrates a mobile device being utilized to scan a tag associated with an object, in accordance with an embodiment of the invention.

FIG. 3 illustrates a system and method for displaying social endorsement data on a social display device, in accordance with an embodiment of the invention.

FIG. 4 illustrates a system for displaying numbers of endorsements by authenticated and non-authenticated users on a social display device, in accordance with an embodiment of the invention.

FIG. 5 illustrates a system for displaying endorsement and comments data on a social display device, in accordance with an embodiment of the invention.

FIG. 6 illustrates various components of a mobile device and a social display device, in accordance with an embodiment of the invention.

FIG. 7 illustrates a system including a plurality of social display devices, in accordance with an embodiment of the invention.

FIG. 8 illustrates the operation of an application on a mobile device for interacting with social display devices and real-world objects, in accordance with an embodiment of the invention.

FIG. 9 illustrates the operation of social display devices in the context of a restaurant, in accordance with an embodiment of the invention.

FIG. 10 is a simplified schematic diagram of a computer system for implementing embodiments of the present disclosure.

### DETAILED DESCRIPTION

The following embodiments describe methods, computer programs, and systems for integrating real-world objects into social networks and facilitating user engagement with them. Embodiments of the invention encourage and/or simplify interactions between social networks and physical objects. Hardware is provided in the form of a social display device to integrate physical objects into online social networks. Such devices make it easy and fun for users to engage with objects and indicate their endorsement on social networks. Additionally, users who are not members of any specific social network can participate as unauthenticated users. In this regard, it will be appreciated that users who are members of a social network but who are not currently logged in or otherwise identified may also participate as unauthenticated users. Users are further able to physically browse popular items as they are indicated by electronic signs.

Various contextual examples illustrating implementations of embodiments of the invention are contemplated. For example, in the context of a furniture store, a user can endorse their favorite couch, see which couches are the most popular, and see which couches their friends have endorsed. In the context of a cocktail bar, a user can endorse specific cocktails, or the context of a restaurant, the user can endorse specific dishes. In the context of a library, a user can endorse a book, or discover popular books while browsing the shelves of the library. In the context of the museum, a user can endorse a specific artifact or exhibit. In one embodiment, any location with a corresponding Internet representation, such as a place page on a social network or other website page, could incorporate a device in accordance with embodiments of the invention to facilitate users sharing their endorsement of the location. It should be appreciated that a location can be synonymous with any of various kinds of establishments, such as shops, restaurants, public places, parks, or any other physical location that can be identified and integrated in a social network as described further herein.

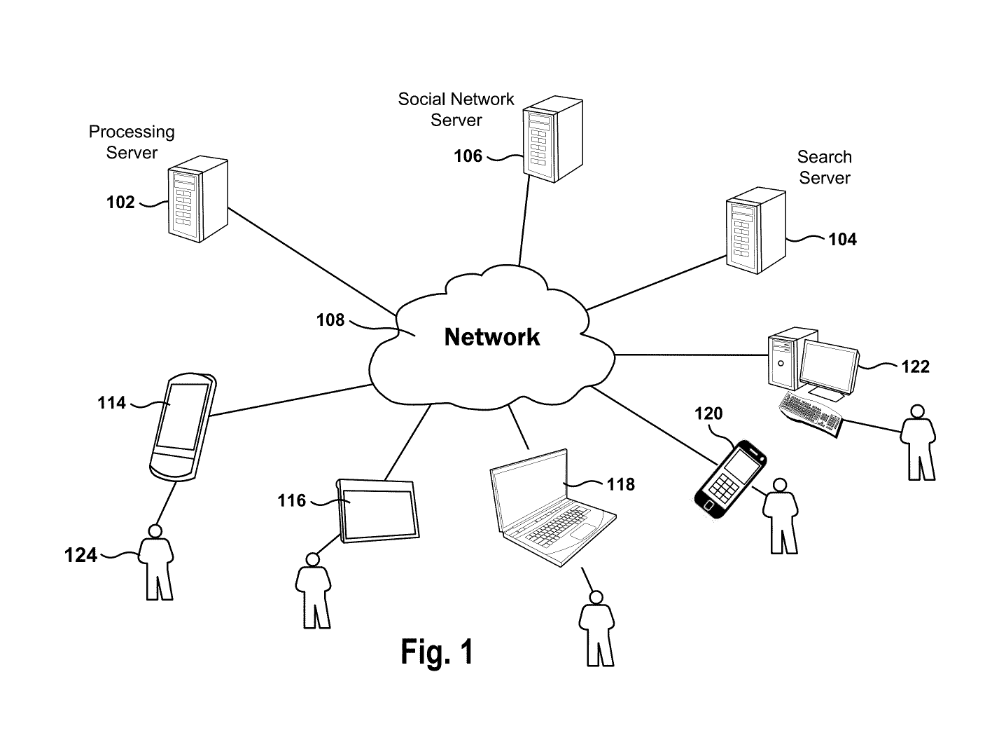

FIG. 1 provides one example architecture of a system that may utilize embodiments described herein. Users 124 interact with each other in the context of a social network, where users can include real people and entities. Each user has an account in the social network, and the account includes at least a user name. In addition, each account can include a profile of the user with additional information about the user, e.g., birth date, residence, favorite activities, etc. The user is in control of what information is added to the profile, and what information is shared with others. A user may access the social network through different devices, e.g., a smart phone 114, a tablet computer 116, a laptop 118, a mobile phone 120, a personal computer 122, or any computing device that provides access to the Internet. Of course, the illustrated devices are only examples.

In accordance with some embodiments, social network server 106 delivers services that enable users to interface with each other. The social network provides a site that enables users to define user accounts, which can be accounts for people and entity accounts. Through those accounts, users are able to connect with their friends, group of friends, entities, groups of entities, etc. In some embodiments, the relationships established in the social network may be utilized in other contexts. Processing server 102 can be configured to perform various additional functions related to the social network, e.g., executing applications which run within the social networking environment, or processing data relating to external sites which have integrated social functionality. Search server 104 provides Internet search capabilities.

It is noted that the embodiments illustrated in FIG. 1 are exemplary. Other embodiments may utilize different servers, have the functionality of one server distributed over a plurality of servers, have the functionality of two or more servers combined into a single server, have a different amount of user categories in the social network, categorize users by different criteria, etc. The embodiments illustrated in FIG. 1 should therefore not be interpreted to be exclusive or limiting, but rather exemplary or illustrative.

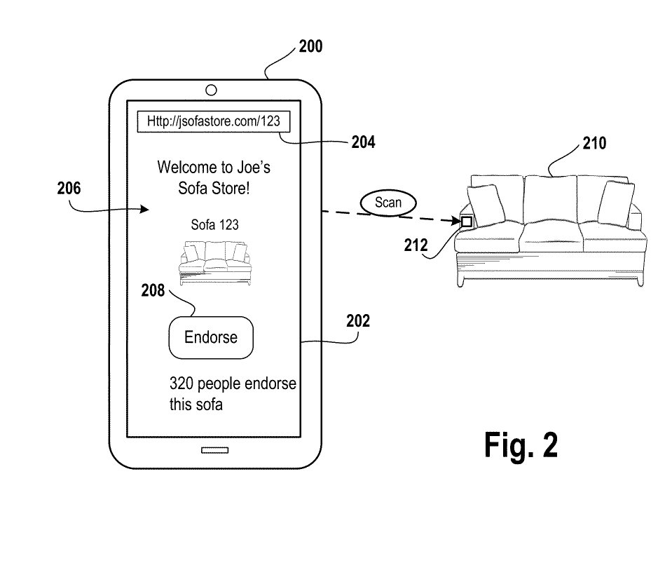

FIG. 2 illustrates a mobile device being utilized to scan a tag associated with an object, in accordance with an embodiment of the invention. In the illustrated embodiment, the mobile device 200 includes a display 202. It should be appreciated that the mobile device 200 can be any of various kinds of mobile or portable devices, such as mobile phones, tablet computers, laptops, portable gaming devices, etc. The mobile device 200 is operated by a user to scan a tag 212, that is associated with a sofa 210. By way of example, the broader context of the illustrated embodiment may be a furniture store in which the sofa 210 is being offered for sale. The tag 212 can be any of various kinds of tags which encode information that can be read by hardware included in the mobile device 200. By way of example, readable tags can include barcodes, QR codes, NFC tags, and other types of tags which can be configured to encode information.

When the tag 212 is read by the mobile device 200, the mobile device acquires a reference 204 to a page 206 corresponding to the sofa 210 (e.g. the tag 212 may be encoded with the reference 204). In one embodiment, the reference 204 is a uniform resource identifier (URI) (e.g. uniform resource identifier (URL) or uniform resource name (URN)) of the page 206. By way of example, the page 206 can be a social network page, a webpage (e.g. a page from a website of the store in which the sofa 210 is being sold), or any other page defined for display in an application executing on the mobile device. The page 206 is displayed on the display 202 of the mobile device 200, for example by way of a browser application executing on the mobile device 200. In one embodiment, the page 206 is a product page for the sofa 210, which may include descriptive information pertaining to the sofa 210, such as pictures, price information, dimensions, materials, options, or any other kind of descriptive information relating to the sofa 210. As shown, the page 206 includes an endorsement button 208 which a user can press to indicate endorsement of the sofa 210 on a social network. The page 206 can also be configured to display information relating to endorsements by users, such as the total number of users who have endorsed the sofa.

It will be appreciated by those skilled in the art that an endorsement on a social network can be variously defined and/or known by other terminology in accordance with the configuration of a particular social network. Merely by way of example, an endorsement on a social network may be defined as a “like,” a “thumbs up,” a vote, a rep, a “+1,” an “endorse,” or any other designation that acts as an indication of endorsement by a user on the social network.

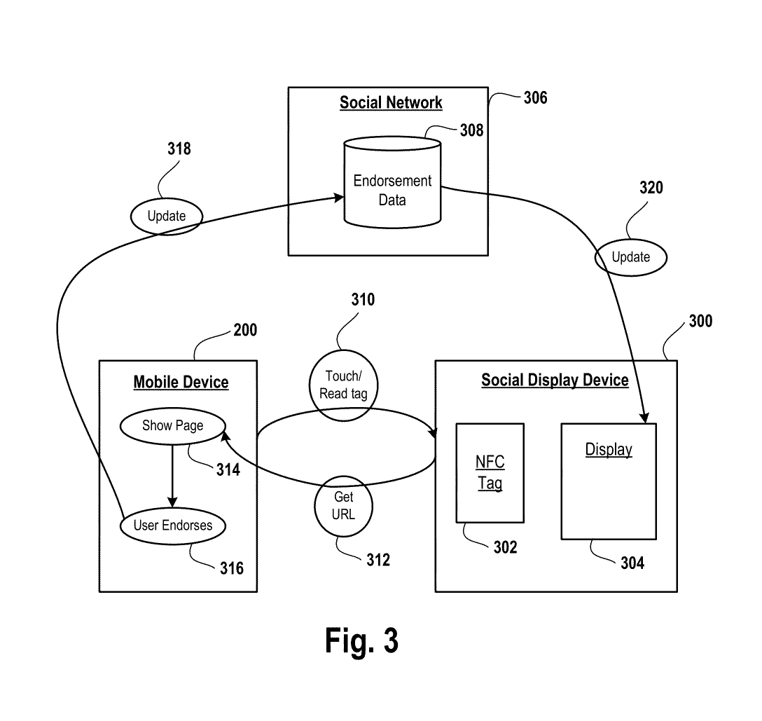

FIG. 3 illustrates a system and method for displaying social endorsement data on a social display device, in accordance with an embodiment of the invention. At operation 310, a mobile device 200 is touched to or held in close proximity to a social display device 300. The social display device 300 includes a tag 302 that is read by the mobile device 200 when the mobile device 200 is held proximate to the social display device 300. In one embodiment, the tag 302 is an NFC tag. Based on reading the tag 302, at operation 312 a URL of an object to which the social display device 300 is associated, is obtained. At operation 314, a page located by the URL obtained from reading the tag 302, is displayed on the mobile device 200. The page includes an endorsement mechanism for enabling a user to indicate endorsement on a social network. At operation 316, the endorsement mechanism is triggered by a user. When this occurs, then at operation 318, an endorsement by the user is defined. Endorsement data 308 of a social network 306 is therefore updated to reflect the newly defined endorsement by the user.

At operation 320, an update is sent to the social display device 300 to facilitate display of current endorsement information based on the endorsement data 308. When the social display device 300 is associated with an object or other item, then the endorsement information displayed on the social display device 300 can indicate information relating to endorsements of the object or item by users. This information is rendered on the display 304 of the social display device 300. By way of example, the endorsement information rendered on the display 304 can include an aggregate number of endorsements by users of the social network, a number of endorsements occurring within a specific time period (such as the most recent 24 hours or week), user names of users who have indicated endorsement, or any other kind of endorsement information which can be determined based on endorsement data which records endorsements by individual users of the social network.

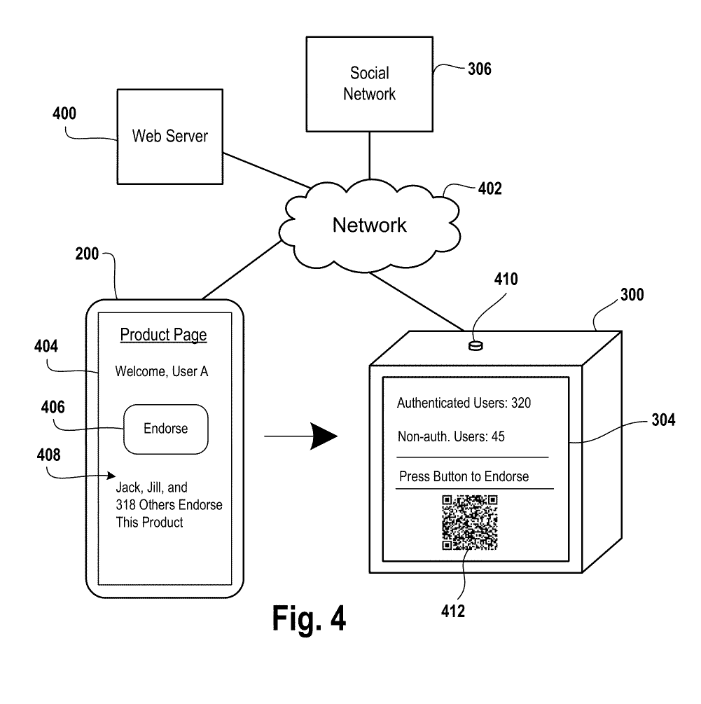

FIG. 4 illustrates a system for displaying numbers of endorsements by authenticated and non-authenticated users on a social display device, in accordance with an embodiment of the invention. As has previously been described, the mobile device 200 is operated to read a tag included in the social display device 300 to obtain a reference to a page that can correspond to an object to which the social display device 300 is associated. A tag such as an NFC tag can be included within the social display device 300. In one embodiment, the display 304 of the social display device 300 can be configured to display a readable tag such as QR code 412. This display may be in addition to the inclusion of an embedded tag such as an NFC tag in the social display device 300, so as to accommodate mobile devices that may not be capable of reading the embedded tag. In the illustrated embodiment, the display page is a product page 404 that corresponds to a product to which the social display device 300 is associated. The reference obtained from reading the tag of the social display device locates the product page 404 from a Web server 400 accessed via a network 402. It should be appreciated that the network 402 can include various kinds of networks which may be interconnected to facilitate communication between the various components in the illustrated embodiment. Such networks may include local area networks, wide area networks, wireless networks, Wi-Fi networks, cellular networks, the Internet, or any other kind of network capable of transmitting data to facilitate communication amongst the components in the illustrated embodiment.

As has been described, the Web server 400 serves page 404 for rendering on the mobile device 200. As shown, the page 404 includes an endorsement button 406 which the user can activate to trigger an endorsement by the user. In one embodiment, the product page 404 may include information identifying the user such as the user's username on the social network 306. It will be appreciated by those skilled in the art that the user may be identified through various mechanisms, including but not limited to prior login by the user on the social network, or prior provision of the user's login credentials on the mobile device 200. Because the user's identity on the social network can be determined, endorsement information that is specific to the current user can be provided. For example, other users who are members of a social graph of the current user, and who have previously indicated endorsement of the product, may be identified or otherwise featured on the product page 404, so as to indicate to the current user those amongst her friends that have indicated endorsement of the product.

In the illustrated embodiment, the display 304 of the social display device 300 is configured to display an aggregate number of authenticated users that have indicated endorsement of the product to which the social display device 300 is associated. Authenticated users are those users that have been identified as members of the social network 306. In one embodiment, the social display device 300 also includes a button 410 for allowing non-authenticated users to indicate endorsement of the product. In other words, when a user presses the button 410, an endorsement of the product by that user is effected. An aggregate count of the number of non-authenticated users that have pressed the button 410 and therefore indicated endorsement of the product is updated. The aggregate count is updated on the display 304 of the social display device 300.

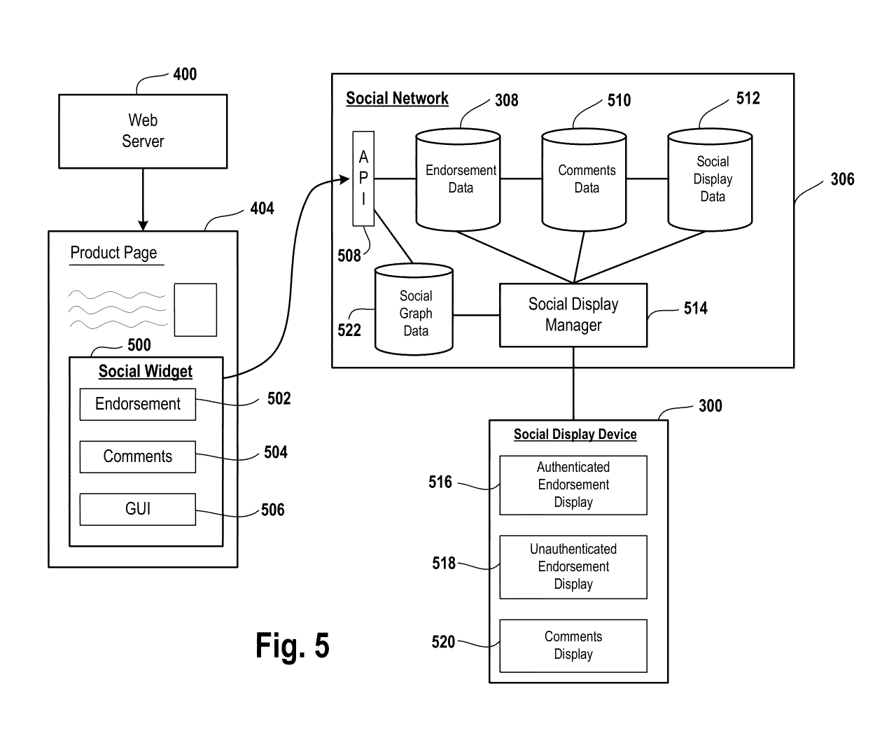

FIG. 5 illustrates a system for displaying endorsement and comments data on a social display device, in accordance with an embodiment of the invention. As has previously been discussed, a product page 404 is provided by a Web server 400 in response to accessing a URL based on reading a tag included in the social display device 300. In the illustrated embodiment, the product page 404 includes a social widget 500 which is configured to provide functionality relating to a social network on the product page 404. The social widget 500 includes an endorsement module 502 which is configured to acquire endorsement data relating to the product page 404 from the social network 306. The endorsement module 502 also is configured to define an endorsement mechanism whereby a user viewing the product page 404 may trigger the endorsement mechanism to indicate endorsement of a product featured on the product page 404. In response to triggering the endorsement mechanism, the endorsement module 502 sends data to the social network 306 indicating that the user has endorsed the product.

The social widget 500 also includes a comments module 504 which is configured to provide comments functionality on the product page 404. The comments module 504 is configured to retrieve comments from users of the social network 306 for display on the product page 404. Additionally, the comments module 504 is configured to receive data defining new comments and transmit such data to the social network 306 for storage.

The social widget 500 further includes a graphical user interface 506. The graphical user interface defines various interface mechanisms for allowing a user to indicate endorsement, generate a new comment, respond to an existing comment, change the sorted order according to which comments are displayed, etc. For example, the graphical user interface 506 can define a button or graphic that is selectable by the user to indicate endorsement. The graphical user interface 506 may also include one or more fields for facilitating text entry by the user to define a new comment. Additional buttons or graphics may accompany existing comments to enable the user to indicate endorsement of a specific comment. These and other types of interface mechanisms can be defined by the graphical user interface 506 to allow the user to interact with and define a social activity on the product page 404.

With continued reference to FIG. 5, the social network 306 is shown to include an API 508, according to which the social widget 500 can access data defined for the social network. The endorsement data 308 includes data defining endorsements by authenticated users of the social network. It will be appreciated that each endorsement by an authenticated user is defined for that specific user of the social network as well as a specific item such as a page, product, or other informational or physical object. The comments data 510 includes data defining comments from users of the social network. Each comment is associated with a particular item and is defined by a specific user of the social network.

Additionally, the social network 306 includes social display data 512, which includes data associated with social display devices, such as the social display device 300. The social display data 512 can include, for example, data identifying a user account to which a social display device is associated, data identifying a specific page to which a social display device is associated, identification information that identifies a specific social display device such as hardware related identification information and the like, reference or URL information encoded by a tag included in a social display device, information relating to an object to which a social display device is associated, or any other kind of information that may be associated with a social display device as defined by the embodiments described herein.

A social display manager 514 communicates with the social display device 300, sending data to the social display device 300 for display on the social display device as well as receiving data from the social display device 300 such as an endorsement by an unauthenticated user. The social display device 300 includes an authenticated endorsement display module 516 that is configured to receive data pertaining to endorsements by authenticated users of the social network for display. As has been noted, these endorsements indicate social network users' endorsement of an object or product to which the social display device 300 is associated. In one embodiment, the authenticated endorsement display module 516 is configured to periodically retrieve data defining an aggregate count of the number of endorsements by authenticated users of the social network. This aggregate count of the number of endorsements by authenticated users is displayed on the social display device, thereby providing a person viewing the social display device with an indication of the popularity of a particular object or product to which the social display device 300 is associated. In another embodiment, the authenticated endorsement display module 516 is configured to receive push data from the social display manager 514 so as to acquire the aggregate count of the number of endorsements by authenticated users.

The social display device 300 also includes an unauthenticated endorsement display module 518, which is configured to receive input from persons indicating endorsement of an object or product to which the social display device 300 is associated, the persons being non-authenticated on the social network. The unauthenticated endorsement display module 518 can be configured to transmit data based on the received input to the social display manager 514 so as to define an unauthenticated user's endorsement of an object to which the social display device 300 is associated. Such data may include a timestamp indicating the time at which a person indicated endorsement. The social display manager 514 may store the data including the timestamp of the endorsement in association with the social display device 300 (and other data relating to the social display device 300) as part of the social display data 512. Additionally, the unauthenticated endorsement display module 518 can be configured to locally store data defining unauthenticated endorsements received at the social display device 300. The unauthenticated endorsement display module 518 can also be configured to retrieve data or receive push data from the social display manager 514 defining an aggregate count of unauthenticated endorsements.

The social display device 300 further includes a comments display module 520 that is configured to retrieve comments from the social network 306 for display on the social display device 300. Such comments are associated with an object to which the social display device 300 is associated. When a user accessing the product page 404 generates a comment via the social widget 500, that comment may be made available for display on the social display device 300 as managed by the comments display module 520.

It will be appreciated that when a user of the social network indicates endorsement or generates a new comment via the social widget 500 included in the product page 404 in relation to an object to which the social display device 300 is associated, the indication of endorsement or the new comment may be posted to a social network activity stream associated with the social network user as well as to the activity streams of other users who are included within a social graph associated with the social network user, or otherwise following the social network user so as to receive updates regarding the social network user's activity. In one embodiment, social graph data 522 can be accessed to effect the display of information on the social display device 300. For example, when an authenticated user operates a mobile device to read the tag included in the social display device 300, and accesses a reference defined from reading the tag, the social display device 300 can be configured to display information based on the authenticated user's social graph. In one embodiment, names of users in the authenticated user social graph that have indicated endorsement of the object to which the social display device 300 is associated can be displayed. In one embodiment, comments from users in the authenticated user social graph can be featured on the social display device 300. In this manner, when the authenticated user operates a mobile device to read the tag of the social display device 300, the experience of information viewable on the social display device 300 is customized to that particular authenticated user.

It will be appreciated by those skilled in the art that various mechanisms for identifying a specific social network user can be applied in the context of embodiments of the present invention. For example, an application for reading the tag of the social display device at a user's mobile device can store login information or other information that identifies the user and facilitates authentication of the user is on the social network when the application is run. As another example, a cookie or other data file can be stored on the mobile device and contain information to authenticate the user to the social network. It will be appreciated that authentication of the user of the mobile device can occur by any mechanism or method in accordance with various embodiments of the invention.

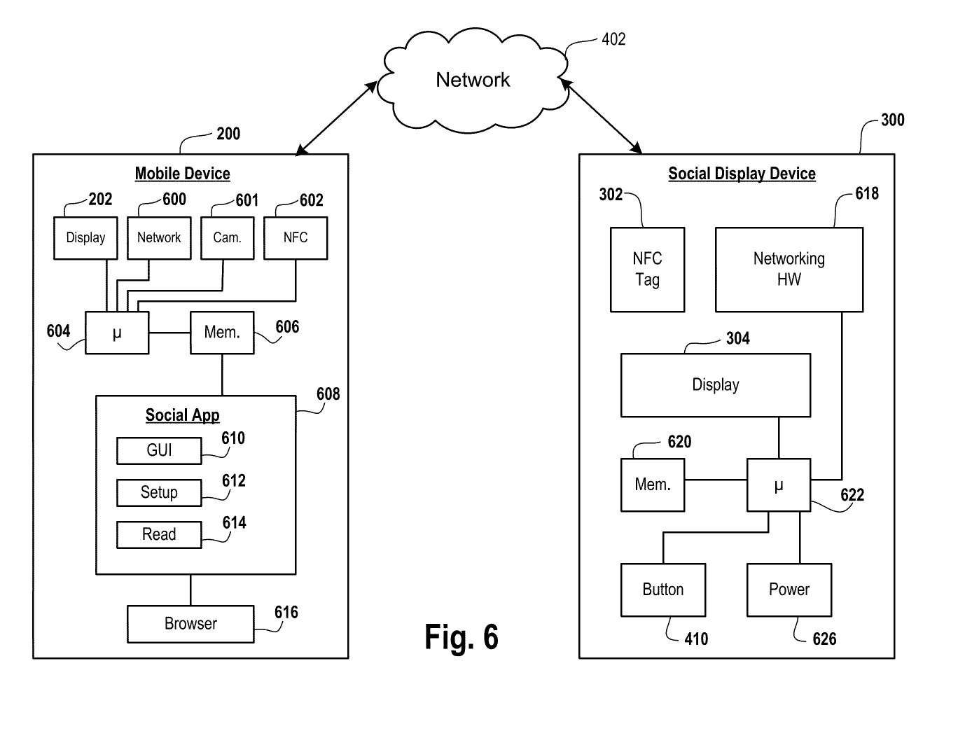

FIG. 6 illustrates various components of a mobile device and a social display device, in accordance with an embodiment of the invention. The mobile device 200 includes a display 202, which can be a touchscreen display to facilitate interactivity and receive input from users interacting with items shown on the display 202. A network module 600 handles network communications of the mobile device 200 to facilitate transmission and receipt of data over a network 402. An image capture device 601 is included for capturing images from the environment. The image capture device 601 can be utilized to capture images of a barcode or the QR code, by way of example. An NFC module 602 includes near field communications hardware capable of reading NFC tags. Mobile device 200 includes at least one processor 604 for executing program instructions, and memory 606 for storing data.

In the illustrated embodiment, a social application 608 is executed by the mobile device 200 to define a social network related functionality. The social application 608 includes a graphical user interface 610 for facilitating interaction and receiving input from a user. The social application 608 additionally includes a set up module 612 for facilitating setup of a social display device 300, as described elsewhere herein. The social application 608 is configured to define a tag reader mode 614 which activates one or more of the image capture device 601 or the near field communications module 602 to read the tag 302 associated with the social display device 300. In one embodiment, upon reading the tag 302, a reference URL is acquired and a browser application 616 is activated by the social application 608 to access the reference URL. The browser application 616 may be activated as a standalone application separately from the social application 608, or may be activated within a subframe of the social application 608 to provide a more integrated experience to the user.

The social display device 300 includes the aforementioned tag 302 which can be an NFC tag or a barcode or a QR code in accordance with various embodiments. Networking hardware 618 handles network communications of the social display device 300. By way of example, the networking hardware 618 may facilitate wireless communication of the social display device 300 over a wireless network such as a Wi-Fi network or a cellular data network. The social display device 300 includes a display 304 for rendering social information relating to object to which the social display device 300 is associated, in accordance with embodiments described herein. The social display device 300 includes at least one processor 622 for executing program instructions and memory 620 for storing data. The button 410 is provided as a mechanism for enabling a non-authenticated user to indicate endorsement of the object to which the social display device 300 is associated. Additionally, the social display device 300 may include a power source 626 such as a battery to allow placement of the social display device 300 with a high degree of freedom.

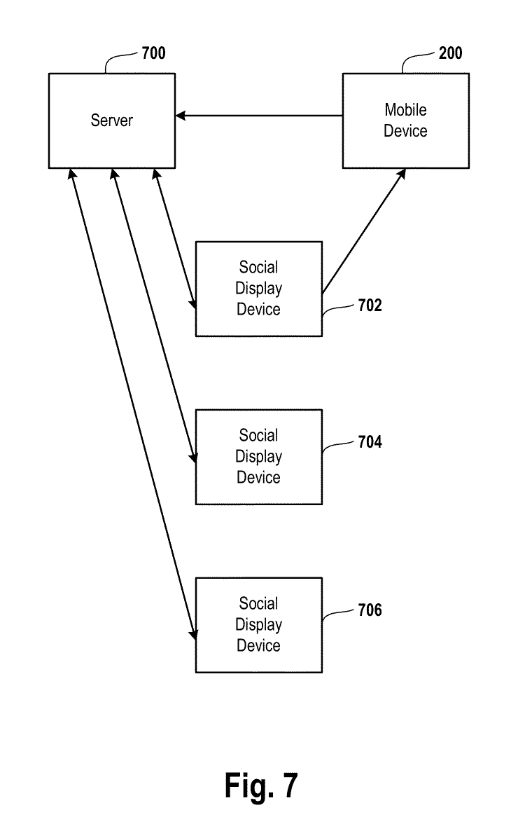

FIG. 7 illustrates a system including a plurality of social display devices, in accordance with an embodiment of the invention. In the illustrated embodiment, social display devices 702, 704, and 706 are shown. Each of the social display devices communicates with a server 700 to both receive information about the number of endorsements relating to objects to which the social display devices are associated, and send information about endorsements from non-authenticated users. The server 700 can be a social network server or other type of server configured to communicate with the social display devices. As has previously been discussed, the mobile device 200 can be operated in the vicinity of one of the social display devices to read its tag and notify the server 700 when the user of the mobile device indicates an endorsement.

It will be appreciated that each of the social display devices can be associated with the same product but in different locations. For example, the same product may be sold at multiple locations of a given store, and therefore each store may have one of the social display devices associated with the product. In this scenario, each social display device can be configured to display endorsement information in specific ways. For example, in one embodiment a social display device can be configured to display the aggregate number of endorsements from authenticated users across all social display devices associated with the same product. In other words, when a specific user operates the mobile device 200 in the vicinity of a specific social display device and endorses the product associated therewith, the aggregate count of endorsements is updated across all the social display devices that are associated with the same product and which are configured to display an aggregate count of endorsements in this manner. The social display devices can therefore be synchronized to display the same aggregated count of endorsements for a given object or product, regardless of which particular device was engaged to generate the endorsement. Additionally, the aggregate count of endorsements can include not only endorsements that have been generated based on interactions with social display devices as has been described, but also endorsements received from users who have accessed an endorsement mechanism for the product via other ways, such as accessing a webpage from a browser that includes an endorsement mechanism for the product.

In a similar manner as that which has been described above, the aggregate count of endorsements from non-authenticated users can also be based on the combined endorsements generated at multiple social display devices. Thus, when a person generates a non-authenticated endorsement at a specific social display device, that non-authenticated endorsement is recorded by the server 700 and the aggregate count of non-authenticated endorsements is updated for display across all social display devices that are configured to display the aggregate count in this manner. It will be appreciated that in other embodiments, a specific social display device can be configured to display the number of endorsements from non-authenticated users which have been generated at that specific social display device only.

Though embodiments of the invention have generally been described with reference to accessing a page for a specific object, it will be appreciated that in other embodiments a page is not accessed. However, an endorsement mechanism associated with an object to which a social display device is associated is provided. For example, the mobile device operated by the user may include an application that upon reading information encoded by the tag included in the social display device, provides an endorsement mechanism to enable the user to endorse the object. Such an application may be configured to obtain other information relating to the object without specifically accessing a webpage as has previously been described.

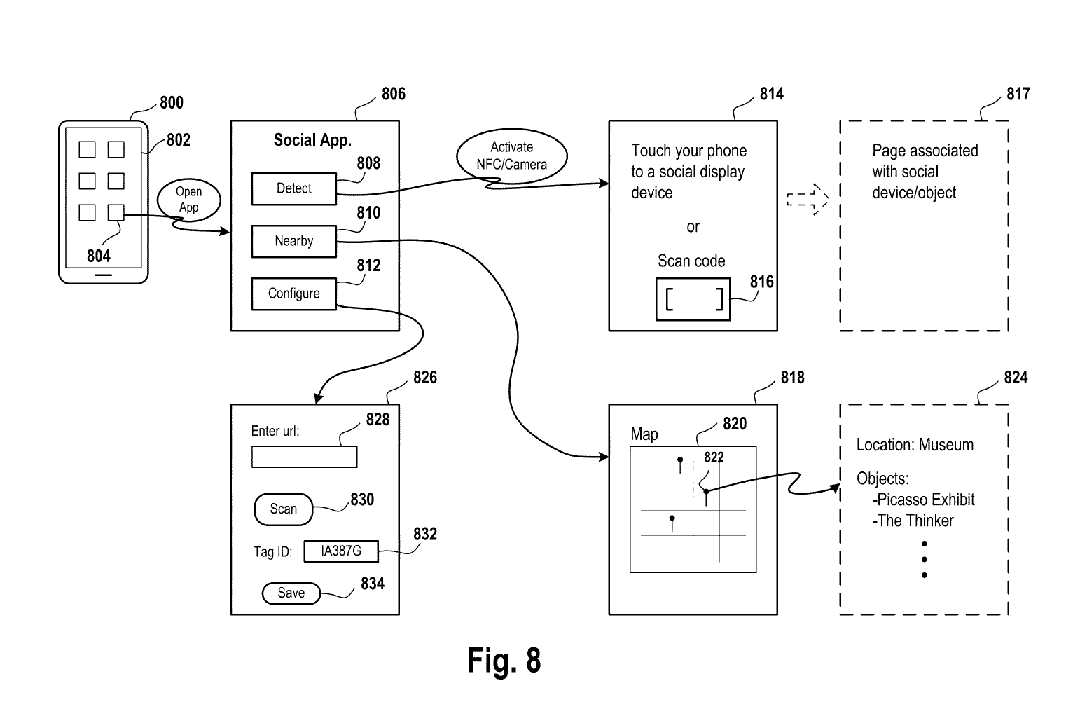

FIG. 8 illustrates the operation of an application on a mobile device for interacting with social display devices and real-world objects, in accordance with an embodiment of the invention. A mobile device 800 is shown having a display 802. On the display 802 of the mobile device 800, an operating system interface is shown through which a user can access various applications installed on the mobile device. When the user accesses a social application 804, a view 806 is presented to the user providing an interface for accessing various features of the social application 804. The various features include a detection option 808, a nearby option 810, and a configuration option 812. As shown, these options can be configured as selectable buttons providing access to each option.

When a user selects the detection option 808, an interface 814 is presented for enabling the user to detect a tag associated with a social display device or a real-world object, such as by scanning an NFC tag, a QR code or a barcode associated with the object. In the illustrated embodiment, the interface 814 instructs the user to touch the mobile device 800 to a social display device. It will be appreciated that activation of detection option 808 triggers activation of detection hardware included in the mobile device 800, such as near field communications hardware or the camera. In one embodiment, the interface 814 can provide a real-time image display 816 of image data being captured by the mobile device's camera, so that the user may position the mobile device to allow the camera to scan a barcode or a QR code or otherwise capture image data of an identifying feature associated with an object.

As discussed herein, the tag can encode a reference to a page associated with the social display device or the object. Thus, this reference is acquired when the tag is read by the social application, and the social application can be configured to navigate to the page identified by the reference. In the illustrated embodiment, a page 817 that is associated with the social device or object is thereby displayed to the user.

In one embodiment, the interface of the social application includes a nearby option 810. When activated, the nearby option provides an interface 818 which is configured to provide information regarding the location of objects that are close by to the user's current location and which provide for the social functionality as described in accordance with embodiments herein. To facilitate this feature, activation of the nearby option can trigger activation of a GPS functionality of the mobile device 800 to determine the current location of the mobile device 800. In one embodiment, a map 820 can be displayed which identifies the locations of social display devices or objects that can be endorsed on the social network in the vicinity of the mobile device 800. In the illustrated embodiment, a selection of a pin 822 identifying a location on the map 820 can provide access to a view 824 providing more specific information about the location and a social display devices or socially interactive objects existing at the location. For example, the addition information may identify the name of a given location, such as the name of a store or other institution, and identify objects at the location which have social display devices associated with them or are otherwise provided with social network interactive features.

In one embodiment, the interface 806 of the social application 804 includes a configure option 812. Selection of the configure option 812 provides access to a configuration interface 826, through which a user may configure a social display device or a readable tag, in accordance with embodiments of the invention. In the interface 826, a reference field is provided for the user to enter a reference to a page, which may be a URL of the page. A scan button 830 can be pressed by the user to initiate scanning of a readable tag, in order to obtain a tag ID 832. In the alternative, the tag ID 832 can be manually entered. By pressing a save button 834, the reference provided will be associated with tag identified by the tag ID 832. Additionally, the association of the reference with the tag may result in encoding of the tag with the reference, so that when the tag is read by a capable device, the reference is obtained by the device.

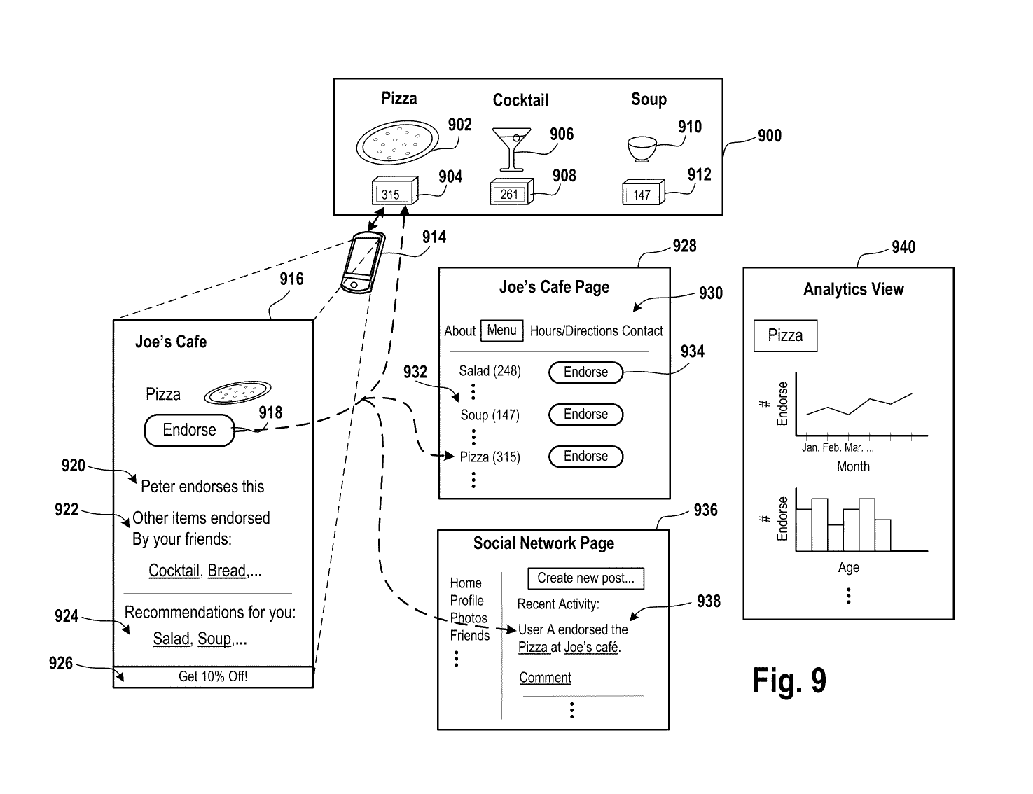

FIG. 9 illustrates the operation of social display devices in the context of a restaurant, in accordance with an embodiment of the invention. In the illustrated embodiment, a restaurant 900 displays various food items which are offered for sale at the restaurant. These include pizza 902, cocktail 906, and soup 910. The pizza 902 has an associated social display device 904; a cocktail 906 has an associated social display device 908; and the soup 910 has an associated social display device 912. A user operates a mobile device 914 to scan a tag included in the social display device 904, thereby acquiring a reference to a page 916 that provides information about the pizza 902. On the page 916, an image of the pizza is shown along with other information. An endorsement button 918 can be pressed by the user to indicate endorsement of the pizza 902 on a social network.

In various embodiments, the page 916 associated with the pizza 902 can be configured to display other types of social information which may be of interest to the user. For example, at reference 920 the page 916 can be configured to indicate other users that have endorsed the pizza who are also members of the primary user's social graph. At reference 922, the page 916 can be configured to indicate other items available at the restaurant 900 which have been endorsed by friends of the primary user on the social network. At reference 924, recommendations of specific items available at the restaurant 900 can be provided to the user based on known information about the user, such as demographic information of the user for the user's endorsement history. For example, items which have been endorsed by other users having a similar demographic profile or similar endorsement history may be prioritized for recommendation to the user. At reference 926, a coupon can be presented to enable the user to obtain a discount at the restaurant 900. The provision of a coupon via the page 916 can serve as an incentive for users to interact with the social functionality made available via the social display devices at the restaurant 900.

As has been discussed, endorsement by the user is recorded on the social network and is propagated through various update channels. For example, the social display device 904 associated with the pizza 902 can be configured to display a total number of endorsements of the pizza, and therefore this total number of endorsements will be updated to reflect the endorsement by the user via the endorsement button 918. Additionally, the number of endorsements of the pizza can be shown in other contexts, such as on a webpage 928 associated with the restaurant 900. In one embodiment, the webpage 928 provides access to various types of information, as shown at reference 930, including information about the restaurant, it's menu, its hours of operation, directions, contact information, or any other information related to the restaurant 900. In the illustrated embodiment, a view of the menu 932 of the restaurant 900 is displayed on the webpage 928. The menu 932 lists various items that are available for purchase at the restaurant, along with endorsement buttons 934, which may be pressed to indicate endorsement of a specific item of the menu on the social network. Additionally, alongside each item of the menu, the total number of endorsements of that item on the social network is provided. Thus by way of example, when the user activates the endorsement button 918 as has previously been discussed, the total number of endorsements for the pizza item listed on the menu 932 in the context of the webpage 928 is updated to include this new endorsement by the user.

Furthermore, when a user endorses an item on the social network, this endorsement can be displayed on a social network page 936, which may be a social network page associated with the endorsing user or associated with another user of the social network (such as a friend of the user on the social network or another use who follows the endorsing user's activity on the social network). As shown, the endorsement by the user via the endorsement button 918 to indicate endorsement of the pizza 902 of the restaurant 900, appears as a posting in an activity stream 938 on the social network page 936.

In one embodiment, analytics tools can be provided to a user to facilitate analysis of endorsement data. For example, the number of endorsements of a given item can be tracked over time, e.g. providing a chart of the number of endorsements by month for the item. Endorsements can also be analyzed based on demographic information available via the social network. For example, endorsements can be analyzed based on various factors such as age, gender, residence or location, income, ethnicity, profession, or any other type of demographic information pertaining to the endorsing users which may be available via the social network.

By way of example, in the illustrated embodiment an owner of the restaurant 900 can be provided with an analytics view 940 which allows the owner to analyze endorsements of the items sold at the restaurant 900. For example, a graph of the number of endorsements occurring over time can be provided, as well as a breakdown of the number of endorsements by age. It will be appreciated by those skilled in the art that any of various types of statistical analyses can be applied to the endorsement data in combination with demographic data of users of the social network. In this manner, owners of social display devices or objects which are provided with social network interactive functionality is described herein will be able to better understand the nature of users who indicate endorsement.

Embodiments of the invention provide for a QR code or NFC tag to be mounted on or next to objects which can be endorsed on the social network. This code or tag can include an underlying URL for the object, e.g. a product page on the merchants website. A dedicated application (or functionality defined in an existing application such as a social networking application) installed on the user's smart phone can read the code or tag and give the user an option to endorse the object, and may also show the current number of endorsements. The application can also allow other types of interactions with the object, such as enabling the user to purchase the object. Additionally, the user may be able to leave comments via the application, which can be made available for display to other users.

It is also desirable to make the production and management of the QR codes or NFC tags and their IDs in relation to the physical objects or locations as easy as possible. This can be achieved by having a mode in the aforementioned application that allows the owner of the tags to link the tag to a new object, or correct the link, or manage the connection in other ways.

Embodiments of the invention are also drawn to a dedicated hardware device that displays the number of endorsements that an object has received and possibly a selection of the most recent comments. Such a device can include hardware for a display, network conductivity, and computing hardware to regularly fetch updates from the network and display them. It will be appreciated that the number of endorsements, comments, or other information displayed on the device are updated in real-time in accordance with embodiments described herein, thus enabling the device to provide a real-time display of social data.

Embodiments of the invention are also drawn to methods facilitating ease of setup of such display devices. For example, a display device may come with a preconfigured ID, which an owner of the device can utilize to register the ID with his personal account on a social network to thereby define his ownership of the devices. The owner may also configure the URL to which a specific device refers and possibly the text that is displayed by that device. In one embodiment, when the display device includes a readable tag, a display device can easily be associated with the user account using the user detail stored on a mobile device that includes a tag reader (such as a smart phone logged into an account of the user for the social network). A user can open a webpage via a browser on their smart phone and share the URL with a set up application that remembers the URL, and the user can scan the tag and open it with the set up application. Based on the combination of contexts, from the signed in setup application, the tag URL, and the browser URL, the tag can be associated with the user and the page.

It should be appreciated that in one embodiment, the social display device may itself be able to configure it's associated NFC tag or QR/bar code to further facilitate easier setup of the device. The NFC tag may be directly controlled from the social display device's micro controller/processor and the display may be used to directly display a QR/bar code code or any other machine readable identifier.

In order to engage users with the social network, such display devices can also include a button (or a touch sensor) that allows a person walking by to express that she endorses or likes the item by pressing this button.

In one embodiment, a display device may include a camera to allow users who are not registered to any social network to take a picture of themselves and share them on the objects page.

In another embodiment, the display device may include a WebCam that streams a live stream of the object to the web.

In another embodiment, users may press a physical endorsement button on the display device itself. Since such users are not logged in, these endorsements are not specific to the social network but can be logged nonetheless and displayed on the device. Such endorsements can be characterized as anonymous endorsements.

In another embodiment, analytics of the people who have endorsed the object can be provided to the owner of the social display device. These can include aggregate reports on gender, sociology, brand of smart phone, time of day, or any other type of analytics based on analysis of endorsements and user data.

In another embodiment, recommendations can be applied to the user based on the objects that they have interacted with.

In another embodiment, in addition to registering endorsements via NFC or QR codes as has been described, an image recognition service can be utilized to allow for endorsement by merely taking a picture of a physical object. In such an embodiment, an image of the object can be captured and analyzed by an image recognition service to identify an object of interest and deliver the reference URL associated with the object.

In another embodiment, by adding GPS capabilities to the display unit, the endorsements can also have location information attached to them. This information can then also be used by the image recognition service to reduce the search space of possible items that match the photograph item, or it can provide users with a list of physical objects within their surrounding that can be endorsed.

In another embodiment, the display device may include a microphone, enabling a user to speak their intent to endorse the item associated therewith, and a server may be configured to use speaker identification to determine who has endorsed the item.

In another embodiment, the display device can include mobile communication capabilities for use as an Internet gateway. In another embodiment, an existing device such as a smart phone can be configured to provide Internet connectivity to display devices (e.g. tethering).

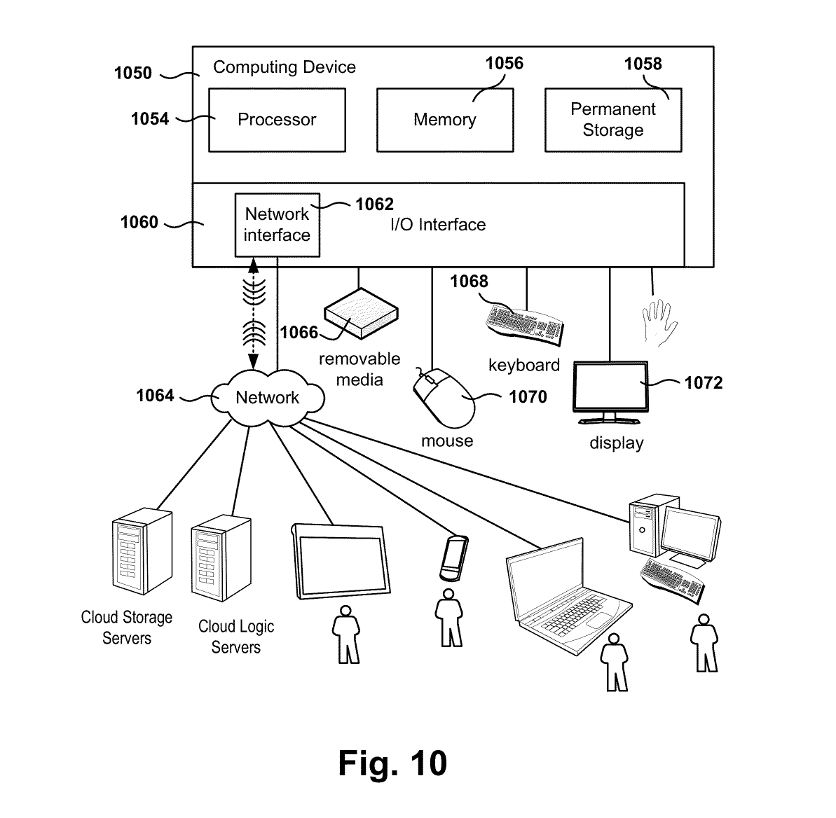

FIG. 10 is a simplified schematic diagram of a computer system for implementing embodiments of the present disclosure. It should be appreciated that the methods described herein may be performed with a digital processing system, which in one embodiment may be a conventional, general-purpose computer system. Special purpose computers, which are designed or programmed to perform only one function, may be used in the alternative. The computing device 1050 includes a processor 1054, which is coupled through a bus to memory 1056, permanent storage 1058, and Input/Output (I/O) interface 1060.

Permanent storage 1058 represents a persistent data storage device, e.g., a hard drive or a USB drive, which may be local or remote. Network interface 1062 provides connections via network 1064, allowing communications (wired or wireless) with other devices. It should be appreciated that processor 1054 may be embodied in a general-purpose processor, a special purpose processor, or a specially programmed logic device. Input/Output (I/O) interface 1060 provides communication with different peripherals and is connected with processor 1054, memory 1056, and permanent storage 1058, through the bus. Sample peripherals include display 1072, keyboard 1068, mouse 1070, removable media device 1066, etc.

Display 1072 is configured to display the user interfaces described herein. Keyboard 1068, mouse 1070, removable media device 1066, and other peripherals are coupled to I/O interface 1060 in order to exchange information with processor 1054. It should be appreciated that data to and from external devices may be communicated through I/O interface 1060. Embodiments of the disclosure can also be practiced in distributed computing environments where tasks are performed by remote processing devices that are linked through a wired or a wireless network.

Embodiments of the present disclosure can be fabricated as computer readable code on a non-transitory computer readable storage medium. The non-transitory computer readable storage medium holds data which can be read by a computer system. Examples of the non-transitory computer readable storage medium include permanent storage 1058, network attached storage (NAS), read-only memory or random-access memory in memory module 1056, Compact Discs (CD), Blu-ray™discs, flash drives, hard drives, magnetic tapes, and other data storage devices. The non-transitory computer readable storage medium may be distributed over a network-coupled computer system so that the computer readable code is stored and executed in a distributed fashion.

Some, or all operations of the method presented herein are executed through a processor. Additionally, although the method operations were described in a specific order, it should be understood that some operations may be performed in a different order, when the order of the operations do not affect the expected results. In addition, other operations may be included in the methods presented, and the operations may be performed by different entities in a distributed fashion, as long as the processing of the operations is performed in the desired way.

In addition, at least one operation of some methods performs physical manipulation of physical quantities, and some of the operations described herein are useful machine operations. Embodiments presented herein recite a device or apparatus. The apparatus may be specially constructed for the required purpose or may be a general purpose computer. The apparatus includes a processor capable of executing the program instructions of the computer programs presented herein.

Further shown are a plurality of other devices, storage, and services that may be connected to network 1064. Network 1064 can be, for example, the Internet. The Internet is interconnected with a plurality of devices, including cloud storage servers, cloud logic servers, user interface devices, etc. Some devices that can communicate with the Internet access services on various cloud logic servers and cloud storage can include, e.g., tablet computers, smart phones, laptops, desktop computers, television systems, and the like. The devices that can communicate with each other require at least a processor, and a display for presenting user interface views from selected programs and code that render the user interfaces. The user interface can be provided through keyboard entry, text entry, voice entry, gesture entry, and combinations thereof.

The user interfaces can be presented in browsers of the various devices, can interpret HTML code, can render video, can communicate over the Internet by way of wireless communication, can render Flash video data, and the like. All of these devices, hardware embodiments, and code are configured for enabling the interfacing and interaction with the social network, and the users of the social network, and users on various websites connected to the Internet. The interaction, through social networks will enable electronic messaging regarding current information, shared interests, chat communication, video communication, and general posting, interests, and relationship management. Broadly speaking, a social network is a site that allows at least two people or entities to communicate with one another and share at least one piece of data.

Although the foregoing embodiments have been described with a certain level of detail for purposes of clarity, it is noted that certain changes and modifications can be practiced within the scope of the appended claims. Accordingly, the provided embodiments are to be considered illustrative and not restrictive, not limited by the details presented herein, and may be modified within the scope and equivalents of the appended claims.

What is claimed is:

1. A method for displaying an aggregate count of endorsements, comprising:
processing a request for an online resource from a mobile device, the online resource being associated with an object, the online resource including an endorsement mechanism;
sending the online resource to the mobile device;
processing an input from a user triggering the endorsement mechanism, to define an endorsement of the object by the user;
updating an aggregate count of endorsements of the object to include the endorsement of the object by the user;
sending the updated aggregate count of endorsements to the social display device for display on the social display device.

2. The method of claim 1 wherein the request for the online resource is defined from a tag on the social display device read by the mobile device to obtain a reference to the online resource.

3. The method of claim 2, wherein the reference is defined by a URL.

4. The method of claim 1, wherein the tag is defined by one or more of a barcode, an NFC tag, or a QR code.

5. The method of claim 1, wherein the online resource defines a social network page associated with the object.

6. The method of claim 1, wherein the online resource is defined by a website of an entity associated with the object.

7. The method of claim 6, wherein the entity is one or more of a retailer, a manufacturer, a restaurant, a business, a museum, or a library.

8. The method of claim 1, wherein processing the input from the user includes publishing the endorsement of the object by the user to one or more users in a social graph associated with the user.

9. The method of claim 1, wherein the endorsement of the object by the user is defined for a social network.

10. The method of claim 1, wherein processing the input includes retrieving and sending to the mobile device one or more of the following based on the endorsement of the object by the user: a recommendation, a coupon, a discount code, an invite, an offer.

11. A method for displaying an aggregate count of endorsements, comprising:
reading a tag on a social display device to obtain a reference to an online resource;
retrieving the online resource, the online resource being associated with an object, the online resource including an endorsement mechanism;
processing an input from a user triggering the endorsement mechanism;
sending a request to a server to increase an aggregate count of endorsements of the object and propagate the aggregate count for display on the social display device.

12. The method of claim 11, wherein the tag is defined by one or more of a barcode, an NFC tag, or a QR code.

13. The method of claim 11, wherein the reference is defined by a URL.

14. The method of claim 13, wherein the online resource defines a social network page associated with the object.

15. The method of claim 11, wherein the online resource is defined by a website of an entity associated with the object.

16. The method of claim 15, wherein the entity is one or more of a retailer, a manufacturer, a restaurant, a business, a museum, or a library.

17. The method of claim 11, wherein the endorsement of the object by the user is shared to one or more users in a social graph associated with the user.

18. The method of claim 11, wherein the endorsement of the object by the user is defined for a social network.

19. The method of claim 11, further comprising, receiving one or more of the following based on the endorsement of the object by the user: a recommendation, a coupon, a discount code, an invite, an offer.

20. A social display device for displaying an aggregate count of endorsements, comprising:
a readable tag encoding a reference to an online resource, the online resource being associated with an object, the online resource including an endorsement mechanism associated with the object, wherein triggering the endorsement mechanism defines an endorsement of the object by a user and updates an aggregate count of endorsements of the object to include the endorsement of the object by the user;
a display configured to display the aggregate count.
